(19) United States
(12) Patent Application Publication
(10) Pub. No.: US 2016/0119363 A1
(43) Pub. Date: Apr. 28, 2016

(54) System and Method for 4D Signature with Intelligent Mobile Cloud Device

(71) Applicant: Wireless Mobi Solution, Inc., San Diego, CA (US)

(72) Inventors: Mohammed Didarul Alam, San Diego, CA (US); Hongxuan Qian, San Diego, CA (US)

(73) Assignee: Wireless Mobi Solution, Inc., San Diego, CA (US)

(21) Appl. No.: 14/524,501

(22) Filed: Oct. 27, 2014

(51) Int. Cl. H04L 29/06

(52) U.S. Cl. CPC H04L 63/126; H04L 63/0853; H04L 63/105

(57) ABSTRACT

A system and its methods using 4D signature to verify ones' online transaction through mobile projector is disclosed for the first time; the purpose is to enhance the security of currently booming e-commence industry. By 4D, we mean a signature that is written in 3D space and 1D time. The speed and the force the writer used are all recorded in great details, and it becomes very hard to be forged. One sample implementation combined with a popular smart phone is described in details. Two mini projectors and two cameras are used in a coordinated way, with one catch even line, and the other catch odd line; and both catch the red green and blue in strictly defined time sequences. Pre-distortion, de-jitter, auto focus and background color compensation methods are also included. Finally, cloud sever is used to improve the authentication accuracy, through the data fusion.

### FIELD OF THE INVENTION

The present patent application generally relates to sensor technologies and more specifically to a system and a method for 4D signature formation with intelligent mobile device using visible light signal processing.

### BACKGROUND

Online fraud accident is a worldwide public safety issue. There are lots of inventions, such as, image lift wet signature capture^{[1]}, and ID image providing^{[2]} that provide solutions. However, all these patents are traditional 2D systems, where only 2D information is recorded. With 3D or 4D signature, not only the left right, up and down information, but also the forward depth information, equivalent to the instantaneous writing force and/or speed at each point can be revealed as well. This information is related to each person's muscle and bone structure, and can not be easily forged.

With the past surge of the commercialization of the mobile devices, the continuing expansion of visible light sensors and the increasing usage of multimedia applications, online communication security demand has seen a steady increase. Researchers are diligently working towards disruptive technology that has not previously been given substantial attention, including visible light projection, virtual keyboard, virtual mouse and virtual pen applications, 3D scanner etc.

As an essential foundation for 3D signature systems, mobile devices with coordinated camera projector pairs have been developed. The conventional 3D scanner system needs high cost laser beaming system^{[3]}, the new system utilize the normal camera sensor and projector, relies on the back end geometric calculation software algorithm to trace down the motion speed of the finger or any sharp object. This eliminates the special writing pad needed for signature, also increase the security, with writing force and speed information.

In addition, it can be connected to 3D printer to print a copy of the signature, if necessary. The latter application could be duplication of any object through the mobile devices.

The current mobile phone project needs manual correction of the focus and shape of the projected image^{[4]}, with coordinated camera projector pair, we are able to obtain 3D or 4D signature, correct the projection shape, automatic focus, and automatic stabilization as well.

### SUMMARY

Considered broadly, a system for 4D signature collecting and verification with intelligent mobile internet comprises a cloud communication device and at least one mobile device. The cloud communication device is configured to communicate with each of the at least one mobile communication device, to determine a current communication environment between the cloud communication device and the mobile communication device, and to control the operating mode of the mobile communication device according to the current security level of the environment. The mobile communication device is configured to scan the signature through at least one of the color light flashing devices, to form the 3D or 4D information. The device and each of the mobile communication devices is configured to perform interlacing of projection to form the virtual layered signature pad. The cloud communication device and each of the at least one mobile communication device are configured to form a secured network, to act as certifier in the network, based on the previous recorded information. The cloud communication device and each of the mobile communication devices is configured to use an artificial intelligence algorithm to judge the amount of the matching, and conclude the true or fraud. The mobile communication device and each of the at least one mobile communication device is configured to deal with the color compensation against the wall color. The mobile communication device and each of the at least one mobile communication device is configured to deal with the device stabilization against the hand movement. The mobile communication device and each of the at least one mobile communication device respectively comprises a shape correction unit and algorithm. The physical layer is one of a plurality of electromagnetic waves, not only limited to visual light. The stand alone projecting device is paired up with any smart phone with related application to form the signature system. The signature is generated by the remote sensor of the internet of things The 3D printing file is generated by the high speed dual projecting system.

### BRIEF DESCRIPTIONS OF THE DRAWINGS

FIG. 1 is a diagram illustrating a system that implements a 4D signature method for intelligent mobile device in accordance with an embodiment of the present patent application.

FIG. 2 illustrates two projectors to form a high resolution virtual signature layer 3D cubic pad through interlacing.

FIG. 3 illustrates two projectors to form a speed (4D) tracking virtual signature pad through visible varying color light.

FIG. 4 illustrates the camera projector to correct the image shape, through the pre-distortion of the image.

FIG. 5 illustrates the camera projector to correct the hand shaking, through the pre-dislocation of the image.

FIG. 6 illustrates the camera projector pairs to complete automatic focusing, through continuous known shape calibration process.

FIG. 7 illustrates the camera projector pairs to complete automatic brightness adjustment, through continuous screen color map calibration process.

FIG. 8 illustrates the camera projector pairs to complete 4D signature capturing process, through coloring of layered pad.

FIG. 9 demonstrates an example of application system configuration.

### DETAILED DESCRIPTION

Reference will now be made in detail to a preferred embodiment of the system and the method for 4D signature with intelligent mobile device disclosed in the present patent application, examples of which are also provided in the following description. Exemplary embodiments of the system and method disclosed in the present patent application are described in detail, although it will be apparent to those skilled in the relevant art that some features that are not particularly important to an understanding of the system and method may not be shown for the sake of clarity.

Furthermore, it should be understood that the system and method disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

Embodiments of the present patent application described hereafter present an active positioning foundation for 4D signature systems. The exact mobile devices for this purpose in the network have been developed. Optical light source and camera pairs are used to fulfill this 4D task, since the conventional 2D system has only static information.

Shape correction techniques are provided according to one broad aspect of the present patent application and may be used on top of such solutions as interlaced projection and scanning to enhance the user experience.

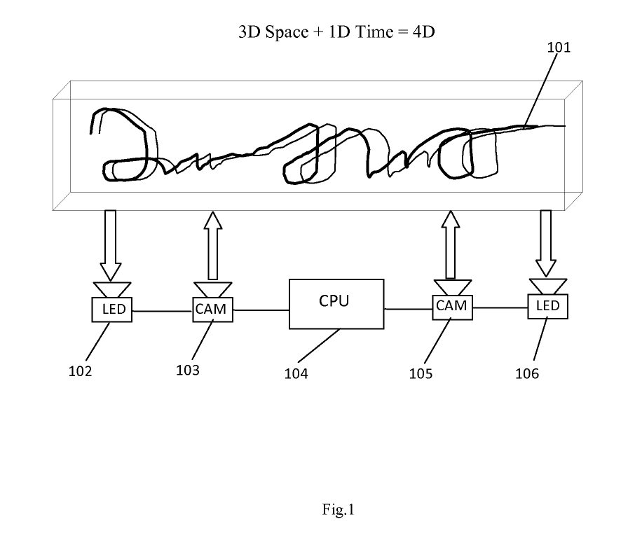

With reference to FIG. 1, 4D signature is realized by 3D space plus time dimension. When signing signature 101, left camera 103 and right camera 105 capture the 4D data and send to LED 102 and 106 respectively to display. The whole process is controlled by CPU 104.

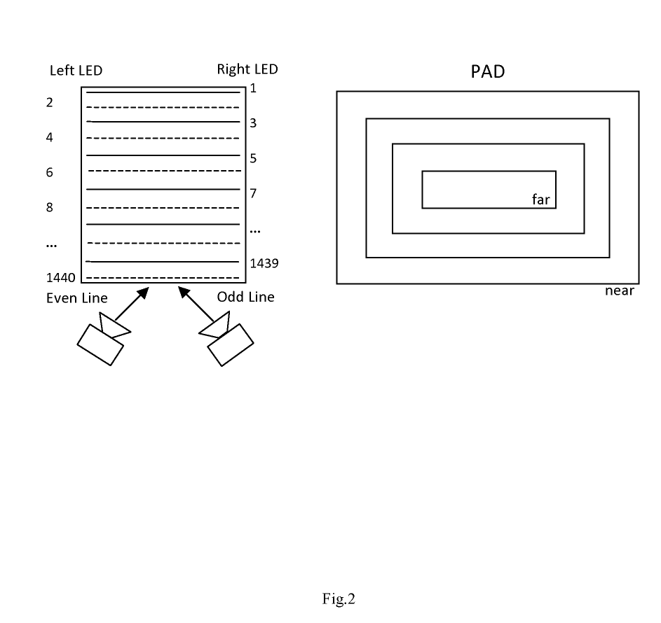

With reference to FIG. 2, high resolution is obtained by two projectors projecting even line and odd line at the same time. If 1440 required, two 720 projector could be used. One of them sweeps Line 1 to 1439, and the other one sweeps Line 2 to 1440. For the depth, several layers of pad could be used from near to far.

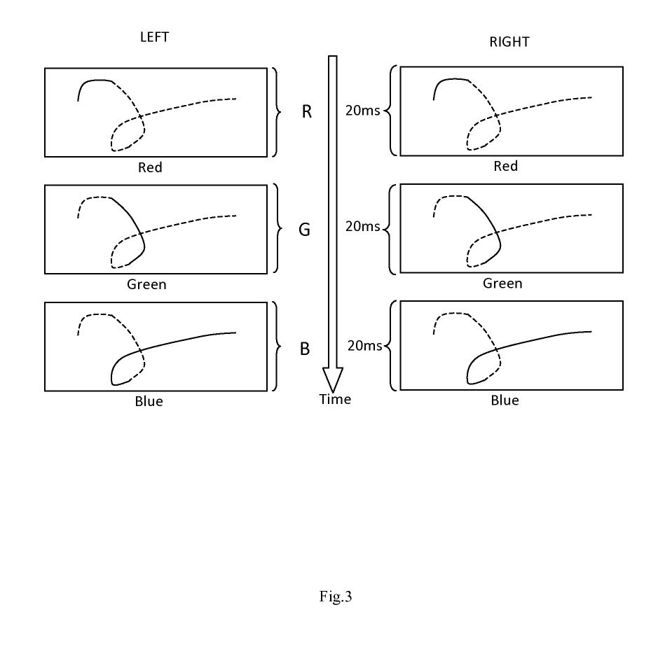

With reference to FIG. 3, same for left and right LED, a certain frequency (e.g. 50 Hz) was set up for RGB data change. In each cycle, the corresponding color will be used for signature captured in this period, then the next color for the next period. The longer the signature in this period, the faster speed is used during this part of the signature.

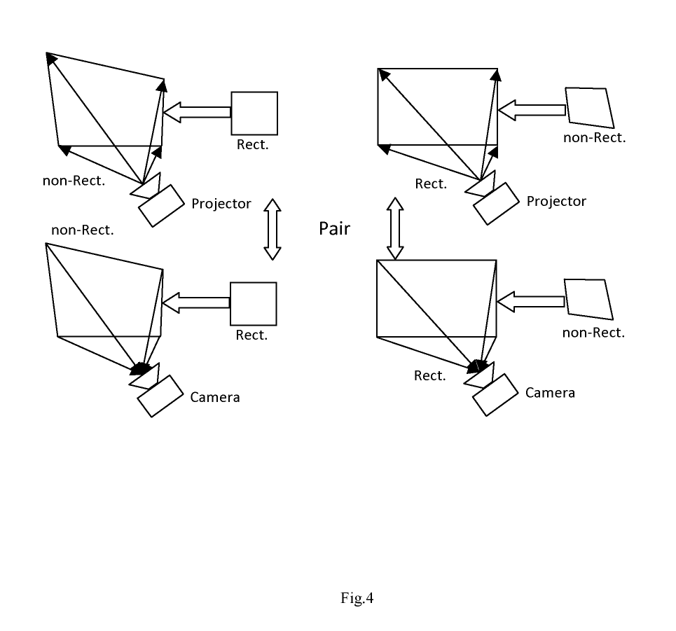

With reference to FIG. 4, same for left and right pair, if a rectangular object is projected non-rectangular in display, the camera will capture its shape and send it to CPU. Then, CPU computes a reverse shape of the non-rectangular display and sends the “pre-distorted” image to the projector. Thus, the final display will soon be rectangular.

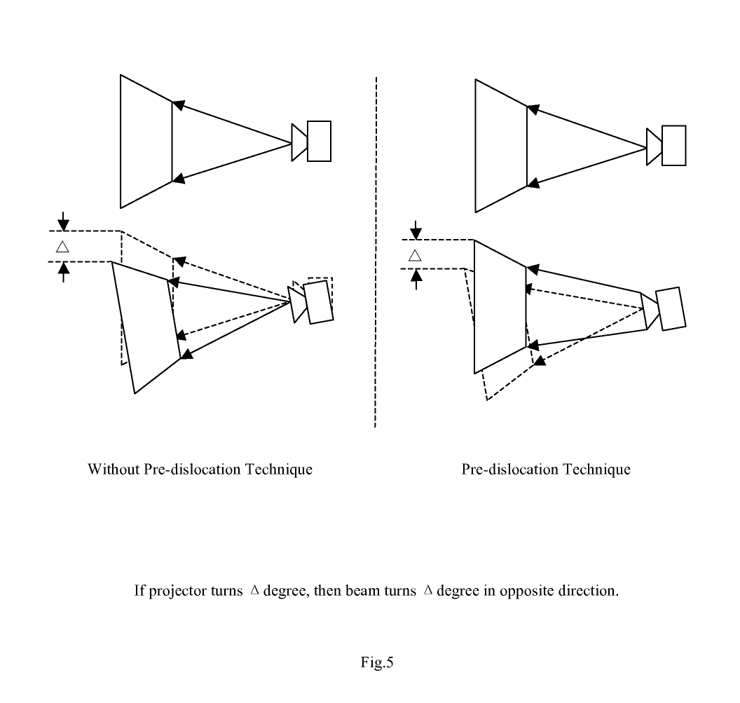

With reference to FIG. 5, when projector turns a small Δ degree, display will also turn Δ degree, like the left half. However, if projector turns Δ degree, beam turns Δ degree in opposite direction, the shake will offset, like the right half.

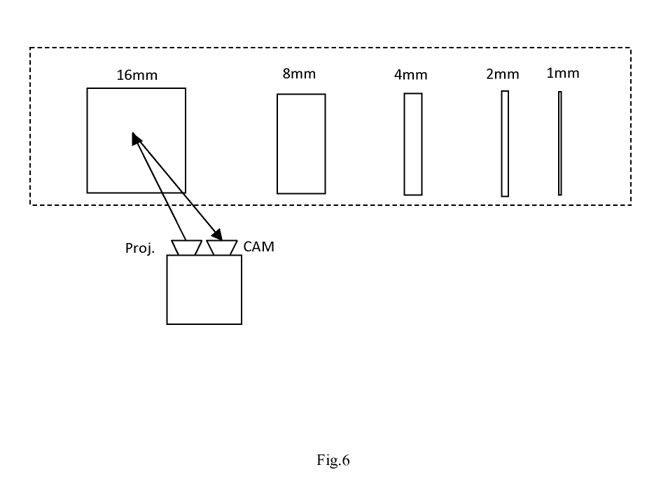

With reference to FIG. 6, a pair of projector and camera is used to do auto focus. E.g., for a 16 mm object, after projected, the camera will capture its shape and send to CPU to compute its projected width. If not equal to 16 mm, CPU will send “auto focus” command to adjust the shape according to the amount of the difference.

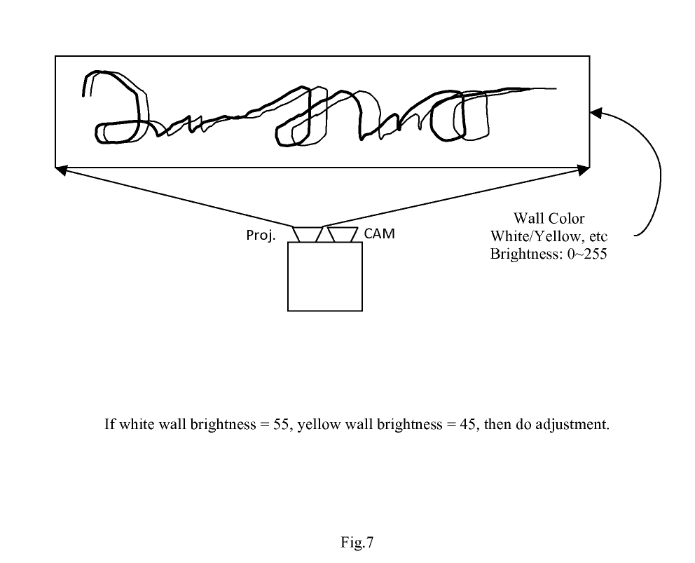

With reference to FIG. 7, a range from 0 to 255 is used for projector/camera pair to describe/capture the brightness. If the brightness of white wall can be defined as 55, when a certain yellow wall is captured 45, the projector will give extra brightness to make up the difference.

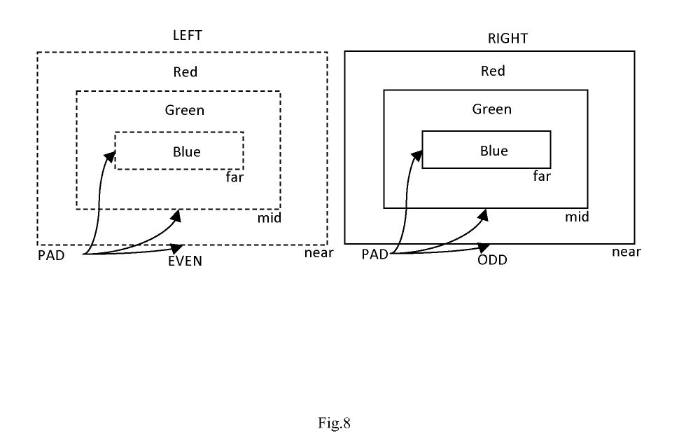

With reference to FIG. 8, same for left and right projector and camera, when an image is projected/captured, the depth information is recorded by a pair of layered pads. Different colors are used to distinguish near and far.

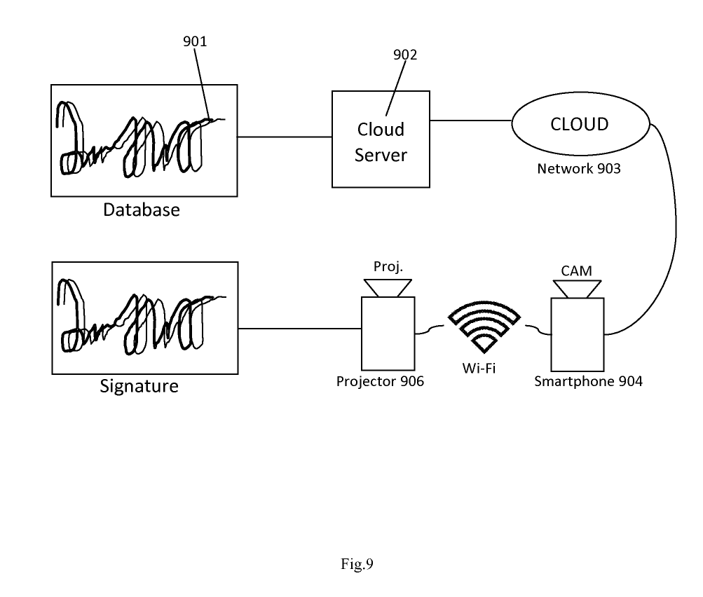

With reference to FIG. 9, assume an existing signature 901 in database is uploaded to cloud network 903 through cloud server 902. Now download and capture the signature by smartphone 904 with a camera. The communication between projector 906 and smartphone 904 is through Wi-Fi. Then projector 906 projects signature 901 to let its owner to see.

An embodiment of the present patent application involves extending 2D signature to 3D or even 4D counterpart(s) for enhanced security, capturing both sign force and sign speed. The multi-layer concept may be used in communication devices to enable the transfer of multi-color light signature over Internet links, for immediately verification against what's recorded in cloud database. In some implementation, applications can be downloaded for this verification purpose.

According to an embodiment of the present patent application, percentage of matching, is adjusted to effectively reach a compromise between security performance and the user friendship level. For example, different transaction amount can be associated with different level of security.

Implementations of the embodiments of the present patent application disclosed herein may also be useful for future Internet of Things communication, where 3D or 4D signature is created by the machine itself.

The visible light principles disclosed herein are also substantially independent of system architecture and may be used for virtually all signals, including thermal imaging, infra-red imaging, laser imaging, radar imaging, microwave imaging or hologram imaging etc.

One basic rule which could be implemented in accordance with an implementation of the embodiments of the present patent application is when flashing the different color on to the virtual signature pad, the receiving imaging can be timed accurate enough to form a true 3D (depth information) or 4D (with additional timing information).

Different speed of flashing will lead to different applications, slow flashing can be used to trace down the signature, high speed flashing can be used to complete 3D scanning for 3D printing.

According to one broad aspect, an embodiment of the present patent application provides an signature system including two input cameras configured to receive flashed light from two synchronized projecting devices. Each camera is configured to receive the reflexed color light from the paired up projecting devices, similar to radar arrays configurations.

Another embodiment of the present patent application provides, in another aspect, an interlacing system including an even line projecting device and an odd line projecting device, working together to form high resolution image on wall.

A method for automated focusing and shape correction is also provided in another embodiment, which includes receiving a skewed or jittering imaging, analyzing the received information to determine conditions of the projector, adapting image in frame buffer based on the determined conditions (including color of the wall), and pre-anti-skew, pre-de-jitter or pre-color correction the image to be subsequently projected on to the wall.

A pre anti-skew is done by the geometrical distance estimation method, pre-de-jitter is based on the image boundary movement detection, pre-color correction is based on visual strength map stored in the device.

According to another embodiment, in a communication system in which a cloud communication device is configured to communicate with each of at least one mobile communication device, the cloud communication device may determine the current communication environment between the cloud device and each mobile device and control the operating mode of each mobile device depending upon the current communication security level for signature verification purpose.

The implementation of the system contains user interface in the application form, light signal generator, optical receiver system, information digital processor and network communication devices.

Although the projecting camera pairs would normally be implemented using hardware, such as ASIC, PLDs (Programmable Logic Devices), FPGAs (Field Programmable Gate Arrays), while other components of the device such as DSP or embedded CPU may be implemented either partially or entirely in software which is stored in a memory and executed by one or more processors. These processors may include, for example, microprocessors, microcontrollers, DSPs, other array processing devices and combinations thereof.

The specific type of each component will be implementation-dependent. The particular structure and operation of the projector-camera may be different for different formats of electromagnetic waves.

In addition, the present patent application is in no way restricted to implementation with mobile devices or other types of device having the specific structure shown in the drawings. Different or fewer components, with different interconnections, may be used in a device in which an implementation of the present patent application can be done.

According to another embodiment, a single communication device incorporates both portable charger, WiFi hot-spot or WiFi Direct, with the projecting devices, can be built to form the said projector-camera pairs with any smart phone, with corresponding applications, to fulfill the 3D or 4D signature collecting and verification procedures.

In one prototype system, part of the projector is sourced from TI DLP6401 processor, the coloring flash is provided by QuickLogic DSI-RGB bridge, both WiFi and LTE is from Qualcomm.

The above embodiments bring a new signature verification concept into the online and off-line retail industries. The embodiments will allow the upgrade of current 2D scan systems to 3D or 4D.

Many different types of implementation and realization of the present patent application are possible. Components or devices described as hardware above may alternatively be implemented partially or substantially in application software. Similarly, method steps disclosed herein may be performed by hardware or implemented in software code.

In the above embodiments, the real-time visible light sensor is used with three color LED modules operating as front end and overlaid high speed embedded processor as back end. A major obstacle to overcome is the imaging resolution, and user friendly experience, including automated lens focusing through the projector camera pairs.

The embodiments effectively eliminate the manual focus, stabilization and shape adjustment. It does so with the projector camera feedback pair. The unique dual camera methodology is optimized for stereo distance calculation. All embedded firmware system implementations are supported.

While the present patent application has been shown and described with particular references to a number of embodiments thereof, it should be noted that various other changes or modifications may be made without departing from the scope of the present invention.

What is claimed is:

1. A system for 4D signature collecting and verification with intelligent mobile internet, the system comprising: a cloud communication device; and at least one mobile device; wherein the cloud communication device is configured to communicate with each of the at least one mobile communication device, to determine a current communication environment between the cloud communication device and the mobile communication device, and to control the operating mode of the mobile communication device according to the current security level of the environment.

2. The system of claim 1, wherein the mobile communication device is configured to scan the signature through at least one of the color light flashing devices, to form the 3D or 4D information.

3. The system of claim 2, wherein the device and each of the mobile communication device are configured to perform interlacing of projection to form the virtual layered signature pad.

4. The system of claim 1, wherein the cloud communication device and each of the at least one mobile communication device are configured to form a secured network, to act as certifier in the network, based on the previous recorded information.

5. The system of claim 4, wherein the cloud communication device and each of the mobile communication device are configured to use an artificial intelligence algorithm to judge the amount of the matching, and conclude the true or fraud.

6. The system of claim 3, wherein the mobile communication device and each of the at least one mobile communication device are configured to deal with the color compensation against the wall color.

7. The system of claim 3, wherein the mobile communication device and each of the at least one mobile communication device are configured to deal with the device stabilization against the hand movement.

8. The system of claim 3, wherein the mobile communication device and each of the at least one mobile communication device respectively comprise a shape correction unit and algorithm.

9. The system of claim 1, wherein the physical layer is one of a plurality of electromagnetic waves, not limited to visual light only.

10. The system of claim 1, wherein the stand alone projecting device is paired up with any smart phone with related application to form the signature system.

11. The system of claim 1, where the signature is generated by the remote sensor of the internet of things.

12. The system of claim 1, where the 3D printing file is generated by the high speed dual projecting system.

13. A method for 4D signature collecting and verification with intelligent mobile internet comprising the steps of:
cloud and mobile device communication configuration
check environment security level
start operation mode
mobile device scans the signature through color light flashing device
form virtual layered signature pad
record 3D/4D information or compare with an existing record
true or fraud recognition [symbol]
